(19) United States
(12) Patent Application Publication
(10) Pub. No.: US 2024/0120749 A1
(43) Pub. Date: Apr. 11, 2024

(54) SYSTEM AND METHOD FOR DETERMINING AVAILABLE BATTERY LEVEL TO AN EXPANDABLE POWER STATION

(71) Applicant: Champion Power Equipment, Inc., Santa Fe Springs, CA (US)

(72) Inventors: Greg Pauken, Hartland, WI (US); James J. Dehn, Brookfield, WI (US); Zhikun Zhong, New Berlin, WI (US); Artur Starosciak, Greendale, WI (US)

(21) Appl. No.: 18/307,262

(22) Filed: Apr. 26, 2023

Related U.S. Application Data
(60) Provisional application No. 63/378,448, filed on Oct. 5, 2022.

(51) Int. Cl. H02J 7/00; H01M 10/0525; H01M 10/48

(52) U.S. Cl. CPC H02J 7/0013; H01M 10/0525; H01M 10/482; H01M 10/488; H02J 7/0048; H02J 7/0063; H02J 2207/20

(57) ABSTRACT

A power station includes an onboard battery system and a control system and is couplable to a plurality of expansion batteries to receive power therefrom. The control system of the power station is configured to determine how many expansion batteries are electrically coupled to the power station, determine a battery level of a battery system of each expansion battery electrically coupled to the power station, and calculate a battery level available to the power station by adding together the battery level of the battery system of each expansion battery electrically coupled to the power station.

### CROSS-REFERENCE TO RELATED APPLICATIONS

The present application is a non-provisional of and claims priority to U.S. Provisional Patent Application Ser. No. 63/378,448, filed Oct. 5, 2022, the disclosure of which is incorporated herein by reference in its entirety.

### BACKGROUND OF THE INVENTION

Embodiments of the present invention are directed to gasless inverter generators or power stations powered by an expandable battery system and, more particularly, to a system and method for determining an available battery level to a power station.

Fuel generators are useful as mobile or backup power sources. They can provide power in locations without access to the utility grid or when natural disasters, extreme weather events, or other conditions result in a power outage. However, fuel generators require a constant supply of combustible fuel which might not be readily available, particularly in remote locations and when natural disasters or severe weather interrupts the fuel supply. Further, these types of generators emit hazardous exhaust and noise, making them unsuitable for indoor environments. Fuel generators also contribute to global warming and require frequent maintenance.

Battery systems can store electrical energy for use in locations without access to the utility grid or when a power outage occurs in the grid. Users of battery systems can charge their battery systems with energy from various sources such as, for example, the utility grid using a converter or rectifier that changes alternating current (“AC”) power into direct current (“DC”) power. Alternatively, such users may elect to charge their battery systems with energy from carbon-free renewable energy sources, the use of which generally reduces dependence on fossil fuels and lowers energy bills. As an example, solar panels can charge battery systems to provide a renewable source of stored energy independent from the utility grid, which is convenient for many mobile and off-grid applications. Battery systems can include batteries connected in series or in parallel to expand capacity in terms of voltage and/or current and can power electrical devices that require AC power using an inverter that transforms DC power into AC power.

The capacity of each battery system with multiple connected batteries depends on the characteristics of each battery. If a user of such a battery system does not know the characteristics of each battery, the user might not know whether the battery system has sufficient capacity for a specific application. Some applications for a battery system may be merely inconvenienced if the battery system requires recharging. However, some battery system applications require the battery system to provide an uninterrupted supply of power, and in that case, a power supply interruption can result in detrimental consequences. Moreover, some battery systems may incur damage if stored for long periods of time while discharged below a certain state of charge (SOC).

Therefore, it would be desirable to provide a portable power station that is powered by a battery system and that can determine a battery level available to the generator and/or display the available battery level to an operator of the generator.

### BRIEF STATEMENT OF THE INVENTION

Embodiments of the present invention relate to a system and method for determining a battery level available to a power station when connected to one or more expansion batteries.

In accordance with one aspect of the invention, a power station assembly includes a plurality of expansion batteries each including a battery system and a power station couplable to the plurality of expansion batteries to receive power therefrom. The power station includes an onboard battery system and a control system. The control system is configured to determine how many expansion batteries of the plurality of expansion batteries are electrically coupled to the power station, determine a battery level of the battery system of each expansion battery electrically coupled to the power station, and calculate a battery level available to the power station by adding together the battery level of the battery system of each expansion battery electrically coupled to the power station.

In accordance with another aspect of the invention, a non-transitory computer readable storage medium has stored thereon a computer program for calculating and displaying the state of charge available to a power station. The computer program includes instructions that cause a processor to determine a number of expansion batteries electrically coupled to and configured to provide power to the power station, with each expansion battery including a battery system. The computer program instructions further cause a processor to determine a state of charge of the battery system of each expansion battery and calculate the state of charge available to the power station by adding together the state of charge of the battery system of each expansion battery.

In accordance with yet another aspect of the invention, a power station connectable to one or more expansion batteries includes an onboard battery system, an automatic display, at least one power output receptacle powered by the onboard battery system, an external battery port electrically connectable to one or more expansion batteries each including a battery system, and a control system electrically coupled to the onboard battery system and the external battery port. The control system is programmed to determine an energy level of the onboard battery system and the battery system of each of the one or more expansion batteries electrically connected to the external battery port, calculate the combined energy level of the battery systems of the one or more expansion batteries electrically connected to the external battery port, and operate the automatic display to display the energy level of the onboard battery system and the combined energy level of the battery systems of the one or more expansion batteries electrically connected to the external battery port.

These and other advantages and features of the present invention will be more readily understood from the following detailed description and the accompanying drawings.

### BRIEF DESCRIPTION OF THE DRAWINGS

The drawings illustrate embodiments presently contemplated for carrying out the invention.

In the drawings:

FIG. 1 is an upper-right front perspective view of a power station, according to an embodiment of the invention.

FIG. 2 is a partial lower-left rear perspective view of the power station of FIG. 1 with power receptacle covers exploded from the power station, according to an embodiment of the invention.

FIG. 3 is a front view of a control panel for the power station of FIG. 1, according to an embodiment of the invention.

FIG. 4 is an upper-right front perspective view of an expansion battery for the power station of FIG. 1, according to an embodiment of the invention.

FIG. 5 is a lower-left rear perspective view of the expansion battery of FIG. 4, according to an embodiment of the invention.

FIG. 6 is a rear view of the power station of FIG. 1 coupled to first and second expansion batteries of the type shown in FIG. 4, according to an embodiment of the invention.

FIG. 7A is an upper-left front perspective view of the power station and expansion batteries of FIG. 6 in a stacked configuration with the first expansion battery positioned on the power station, a pair of stack adaptors positioned on handles of the first expansion battery, and the second expansion battery positioned on the first expansion battery via the pair of stack adaptors, according to an embodiment of the invention.

FIG. 7B is an exploded partial perspective view of the first and second expansion batteries and stack adaptors of FIG. 7A, according to an embodiment of the invention.

FIG. 8A is a power station display of the control panel of FIG. 3 showing a 100% battery level for a power station, according to an embodiment of the invention.

FIG. 8B is a power station display of the control panel of FIG. 3 showing a 10% battery level for a power station, according to an embodiment of the invention.

FIG. 8C is a power station display of the control panel of FIG. 3 showing a 300% battery level for a power station and three expansion batteries connected thereto, according to an embodiment of the invention.

FIG. 9 is a block diagram of a power station assembly, according to an embodiment of the invention.

FIG. 10A is an upper-left front perspective view of a battery charger for the expansion battery of FIG. 4, according to an embodiment of the invention.

FIG. 10B is a lower-left rear perspective view of the battery charger of FIG. 10A, according to an embodiment of the invention.

FIG. 11 is a flow chart illustrating steps in determining and displaying the combined energy level of expansion batteries connected to a power station, according to an embodiment of the invention.

### DETAILED DESCRIPTION

The operating environment of the invention is described herein with respect to a portable power station. However, those skilled in the art will appreciate that the invention is equally applicable for use with nonportable power stations. Furthermore, while the invention is described with respect to a battery-operated power station having an inverter that converts DC power to AC power, embodiments of the invention are equally applicable for use with battery-operated power stations having a DC-to-DC power converter.

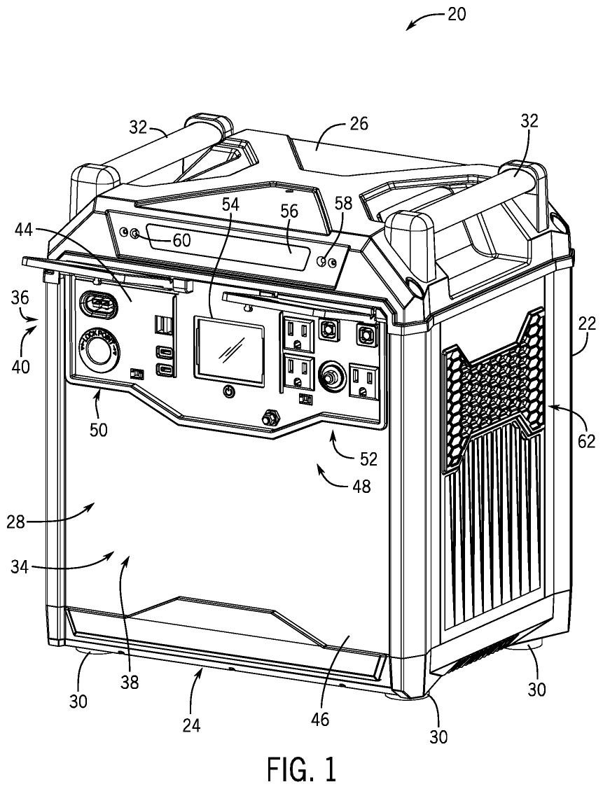

Referring to FIG. 1, a portable power station for providing power to electrical devices (not shown in FIG. 1) is shown, according to an embodiment of the invention. The power station 20 includes a housing 22 having a base 24, a top wall 26, and a plurality of sidewalls 28 that surround and protect internal components of the power station 20. The power station 20 may include a plurality of feet 30 extending downward from the base 24 to provide a stable foundation and to raise the housing 22 slightly off the floor or ground. The power station 20 may include a pair of carrying handles 32 extending upward from the top wall 26 to lift and carry the power station 20. While the carrying handles 32 are shown in FIG. 1 as being oval-shaped, in various embodiments, the carrying handles 32 may have another shape that is comfortable to a user. A single person may be able to lift the power station 20 with one or both of the carrying handles 32, and thus the power station may provide a convenient mobile power source.

The power station 20 typically includes an onboard battery system 34 including one or more batteries (not shown in FIG. 1) and a control system 36 positioned within the housing 22. The onboard battery system 34 may include a rechargeable lithium-ion battery 38 with a chemistry of either nickel manganese cobalt (NMC) or lithium iron phosphate (LFP). The control system 36 may include a converter (not shown in FIG. 1) for converting a voltage from the onboard battery system 34 into another voltage required to operate the electrical devices. The control system 36 may include an inverter 40 to change DC power from the onboard battery system 34 into AC power supplied to the electrical devices. For example, the inverter 40 may provide single or three phase AC power at 50 Hz or 60 Hz. Accordingly, the power station 20 may be referred to as a gasless inverter generator 20.

The power station 20 is shown with a control panel 44 located on a front sidewall 46 of the power station 20. The control panel 44 controls operation of the power station 20 and connects to one or more electrical devices powered by the power station 20. The control panel 44 includes one or more power output receptacles 48 (for example, sockets) that receive electrical connections (for example, plugs) from the electrical devices. The power output receptacles 48 are generally powered by the onboard battery system 34 via the control system 36. The one or more power output receptacles 48 are shown as a plurality of DC power output receptacles 50 and a plurality of AC power output receptacles 52, with the inverter 40 providing AC power to the AC power output receptacles 52. The control panel 44 includes a display 54 to show operating characteristics of the power station 20. The display 54 is typically an automatic display 54 displaying one or more items of information that the control system 36 automatically stores and updates without user input and will be referenced as the automatic display 54 below. However, in some embodiments, the display 54 may also display one or more items of information that control system 36 does not automatically update or may be configured in a manner that requires a manual input from a user for all information updates. The automatic display 54 can display a battery level of the power station 20 to a person using the power station 20. Herein, the battery level of the power station 20 is also referred to as the energy level, charge level, or state of charge of the power station 20. The automatic display 54 may display the battery level in terms of percentages. As such, the battery level is also referenced herein as a percent battery level. The battery level of the onboard battery system 34 may correspond to the battery voltage.

The control system 38 may determine the power and voltage output from the power station 20 via measured voltage, current, and/or power values from one or more voltage, current, and/or power sensors (not shown) on the power station 20. Depending on the type of sensor used, the control system 38 may either utilize measured values from the sensors directly or calculate values based on the measured values. Thereafter, the control system 38 may determine the battery level based on the voltage of the onboard battery system 34 and calculate the percent battery level of the onboard battery system 34 at a point in time based on the determined battery level and the battery level capacity of the onboard battery system 34.

The front sidewall 46 also shows an LED light 56 to illuminate a work area in front of the power station 20 and an LED light button 58 to turn on and off the LED light. An overload reset button 60 is positioned above the control panel 44 adjacent the LED light 56. The overload reset button 60 can be pressed to re-energize the DC and AC power output receptacles 50, 52 if they have been shut off due to an electrical fault. Cooling vents 62 are positioned in one or more of the sidewalls 28 to provide cooling air to components within the housing 22.

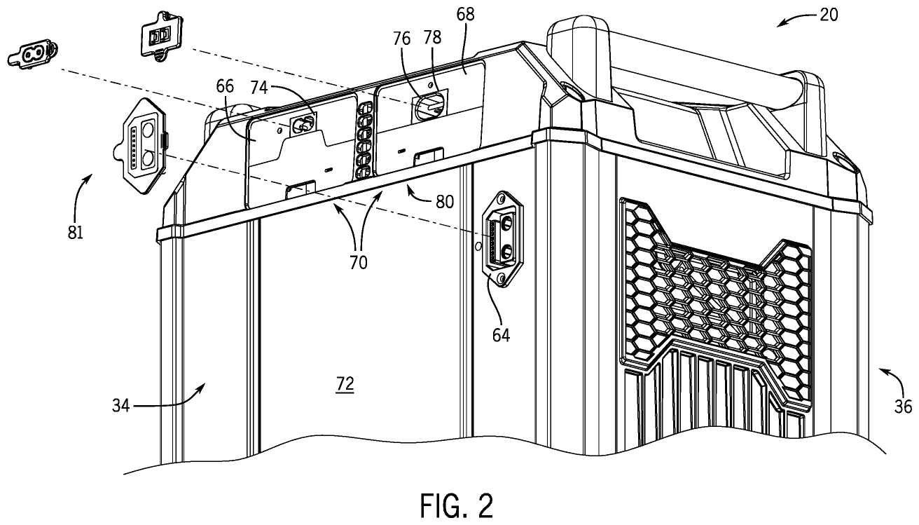

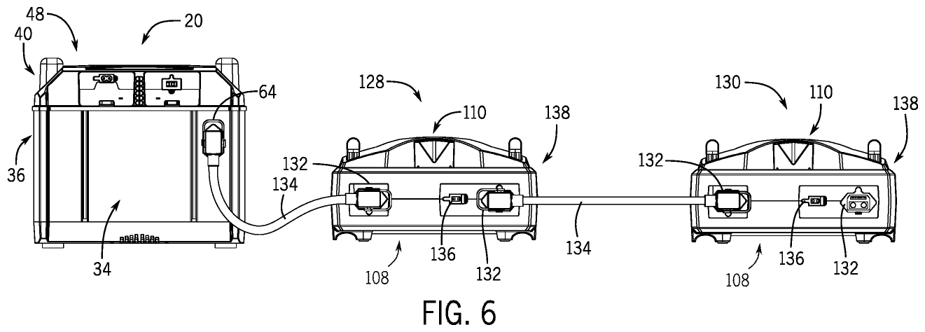

Referring now to FIG. 2, the backside of the power station 20 is shown with receptacle covers 81 exploded therefrom, according to an embodiment of the invention. The power station 20 includes an external battery port 64 to connect one or more expansion batteries (not shown in FIG. 2), as explained in more detail below with respect to FIG. 6. The power station 20 may couple to a single expansion battery or to a string of expansion batteries (for example, up to ten or more) to increase the battery or energy capacity and runtime of the power station 20. The control system 36 couples the onboard battery system 34 and the external battery port 64 to each of the power output receptacles 48 (FIG. 1).

FIG. 2 shows an AC charging module 66 and a DC charging module 68 that charge the onboard battery system 34 from an AC power source (not shown in FIG. 2) and a DC power source (not shown in FIG. 2), respectively. The AC charging module 66 and the DC charging module 68 are positioned within charging module slots 70 in a back sidewall 72 of the power station 20. Charging terminals (not shown in FIG. 2) are located within the charging module slots 70 and electrically connect the AC and DC charging modules 66, 68 to the power station 20 when the charging modules 66, 68 are inserted into the charging module slots 70. If a charging module with a different electrical configuration is desired, the AC charging module 66 and the DC charging module 68 can be removed from the charging module slots 70 for replacement.

The AC and DC charging modules 66, 68 have respective AC and DC power inlet receptacles 74, 76 each coupled to the onboard battery system 34 to recharge the power station 20. The AC charging module 66 may include a rectifier (not shown in FIG. 2) to convert AC power from an AC source into DC power supplied to the onboard battery system 34. The AC power inlet receptacle 74 may charge the power station 20 from a traditional wall outlet (not shown in FIG. 2) connected to the utility grid (not shown in FIG. 2). The DC power inlet receptacle 76 may include an APP (Anderson Power Pole) input port 78 that can support DC charging from one or more solar panels (not shown in FIG. 2). The DC charging module 68 may include a maximum power point tracking (MPPT) module 80 to optimize charging of the onboard battery system 34 from the solar panels. The receptacle covers 81 protect the external battery port 64, the AC power inlet receptacle 74, and the DC power inlet receptacle 76 from moisture, dirt, and other debris.

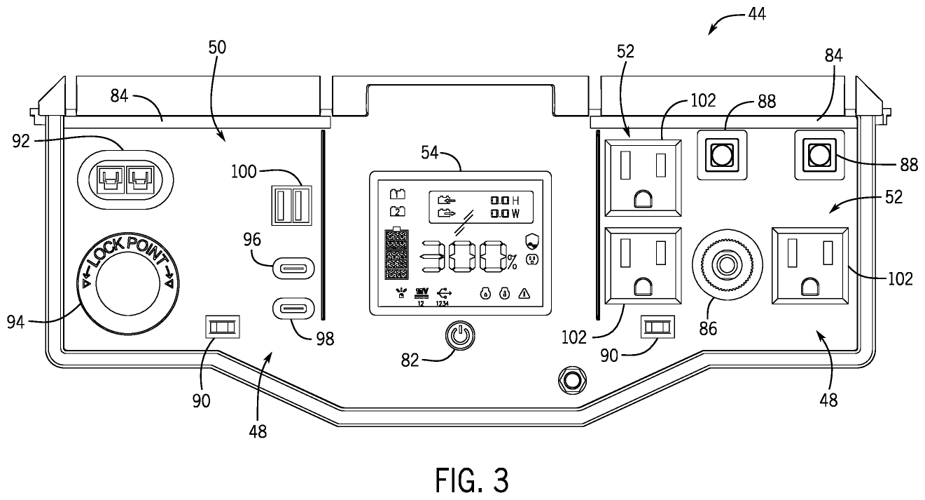

Referring now to FIG. 3, the control panel 44 of the power station 20 of FIG. 1 is shown, according to an embodiment of the invention. The control panel 44 includes a power button 82 to turn on and off the power station 20 and to illuminate the automatic display 54. The automatic display 54 can indicate the battery level available from the onboard battery system 34 and any connected expansion batteries (not shown in FIG. 3) to a user. The control panel 44 also includes a circuit breaker 86, linking kit connection ports 88, and a plurality of selectively openable protective covers 84. The circuit breaker 86 protects the power station against electrical overloads and can be pressed by an operator to reset power to the power output receptacles 48. The linking kit connection ports 88 are used to electrically couple AC power outputs from the linking kit connection ports 88 of two power stations 20 to a linking kit or module (not shown in FIG. 3) that is able to provide an increased AC power output. The protective covers 84 are hinged to the control panel 44 to selectively cover the power output receptacles 48 and are latched in closed positions by depressible cover locks 90.

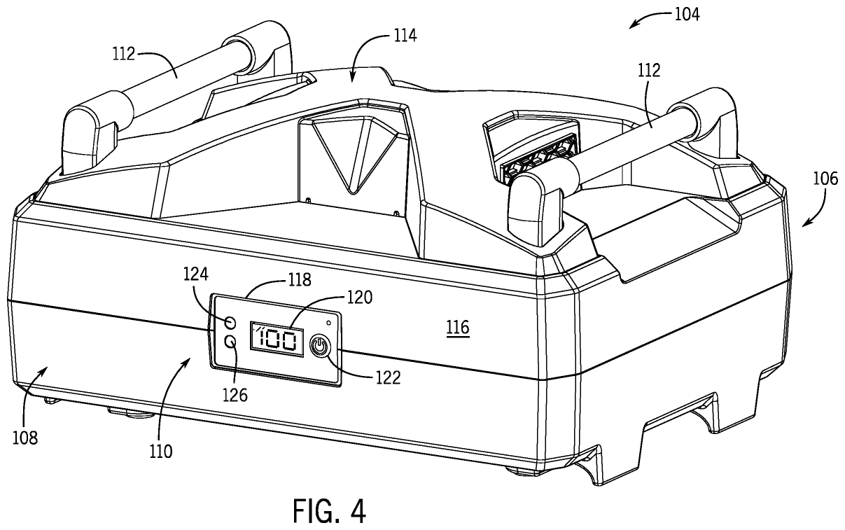

The control panel 44 is shown with a plurality of DC power output receptacles 50 that are powered by the onboard battery system 34 and/or any connected expansion batteries 104 (FIG. 4) and that may output different levels of voltage and current. For example, an APP (Anderson Power Pole) port 92 may supply electrical power for operation of 12-volt (12V) DC, 20-amp (20 A) electrical loads. A regulated automotive port 94 may supply electrical power for operation of 12V DC, 10 A electrical loads. A plurality of Universal Serial Bus (USB) ports may provide power to devices such as, for example, cellphones, laptops, and tablets. A USB Type-C+Power Delivery (PD) port 96 may supply 5V/9V/12V/15V/20V DC, 3 A Fixed or 3.3V-21V DC according to the Programmable Power Supply (PPS) protocol to provide power up to a maximum of 60 watts (60 W) with PD compatible devices. A USB Type-C+Quick Charge (QC) port 98 may supply 3.6V-12V DC, 3 A Fixed (for example, 5V/9V, 3 A Fixed and 12V, 2.5 A Fixed) or 3.6V-12V DC PPS to provide power up to a maximum of 30 W with QC 3.0 compatible devices. USB Type-A ports 100 may supply a maximum of 5V DC, 2.1 A.

The control panel 44 is also shown with a plurality of AC power output receptacles 52 that are powered by the onboard battery system 34 and/or any expansion batteries 104. For example, National Electrical Manufacturers Association (NEMA) 5-15R ports 102 may be used to supply electrical power for operation of 120V AC, 15 A, single phase, 60 Hz electrical loads. However, the AC power output receptacles 52 may provide power from the inverter at any suitable current (for example, any integer or half-integer value from 2.5 A to 30 A) and voltage (for example, any integer value from 110V to 120V AC or any integer value from 220V to 250V AC). In various embodiments, the power button 82 turns on the inverter 40 (FIG. 1) to power the AC power output receptacles 52 while the DC power output receptacles 50 are configured to always receive power.

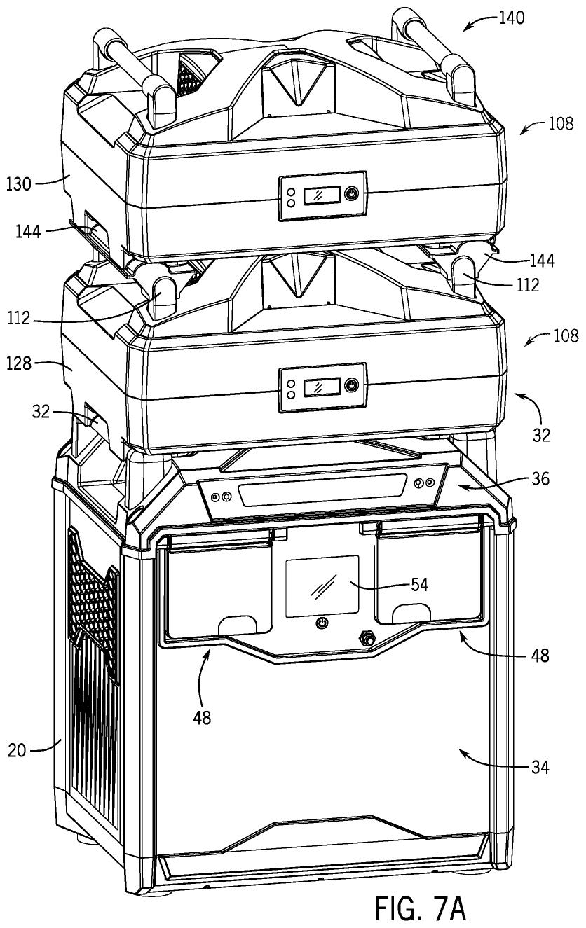

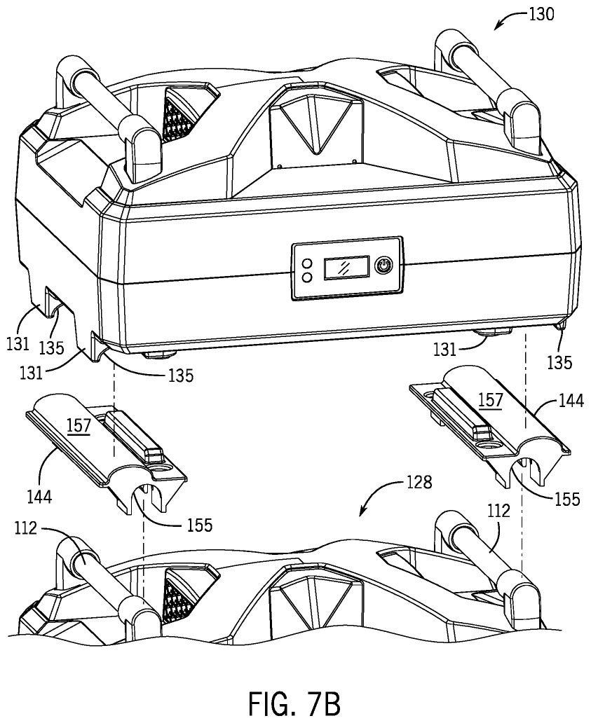

Referring now to FIG. 4, an expansion battery 104 for supplying additional power to the power station 20 of FIG. 1 is shown, according to an embodiment of the invention. The expansion battery 104 may include a housing 106 with a battery system 108 including one or more batteries and a control system 110 positioned within the housing. In some embodiments, the battery system 108 is a rechargeable lithium-ion battery with a chemistry of either nickel manganese cobalt (NMC) or lithium iron phosphate (LFP). The control system 110 operates the expansion battery 104 and may include a converter (not shown in FIG. 4) for converting the voltage of battery system 108 into another voltage supplied to the power station 20. A pair of carrying handles 112 extend upward from a top surface 114 of the housing 106 and can be used to lift the expansion battery 104 or to support another expansion battery 104 resting on the handles 112 when in a stacked configuration, as explained in more detail below with respect to FIGS. 7A and 7B.

A front sidewall 116 of the housing 106 includes a display 118 that shows operating characteristics of the expansion battery 104. The display 118 is generally an automatic display 118 displaying one or more items of information that the control system 110 automatically stores and updates without user input and will be referenced as the automatic display 118 below. However, in some embodiments, the display 118 may also display one or more items of information that the control system 110 does not automatically update or may be configured in a manner that requires a manual input from a user for all information updates. The automatic display 118 includes a fuel or battery gauge 120 that shows a remaining battery level for the expansion battery 104 in terms of percentages. As indicated above with respect to FIG. 1, the remaining battery level may correspond to the battery voltage, and the battery level percentage value is also referenced as a percent battery level. The control system 110 may determine the percent battery level via a measured value from a voltage sensor (not shown) on the expansion battery 104. Depending on the type of voltage sensor, the control system 110 may either utilize measured values from the voltage sensor as voltage values/battery levels or calculate battery levels based on the measured values. Thereafter, the control system 110 may determine the battery level based on the voltage of the battery system 108 and calculate the percent battery level of the battery system 108 at a point in time based on the determined battery level and the battery level capacity of the battery system 108.

The automatic display 118 may also display fault codes when faults occur such as high or low temperature faults, battery or circuitry communication faults, or a battery management system (BMS) fault, as non-limiting examples. A display button 122 turns on/off the automatic display 118 and illuminates the fuel gauge 120. A discharging indicator LED 124 will illuminate red when the automatic display 118 is turned on and the expansion battery 104 is discharging to the power station 20. A charging indicator LED 126 will illuminate green when the automatic display 118 is turned on and the expansion battery 104 is charging.

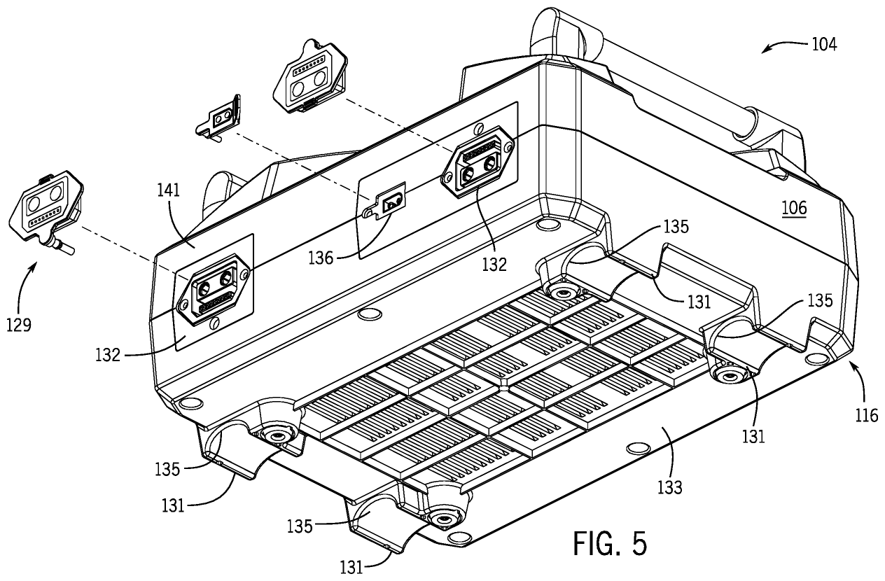

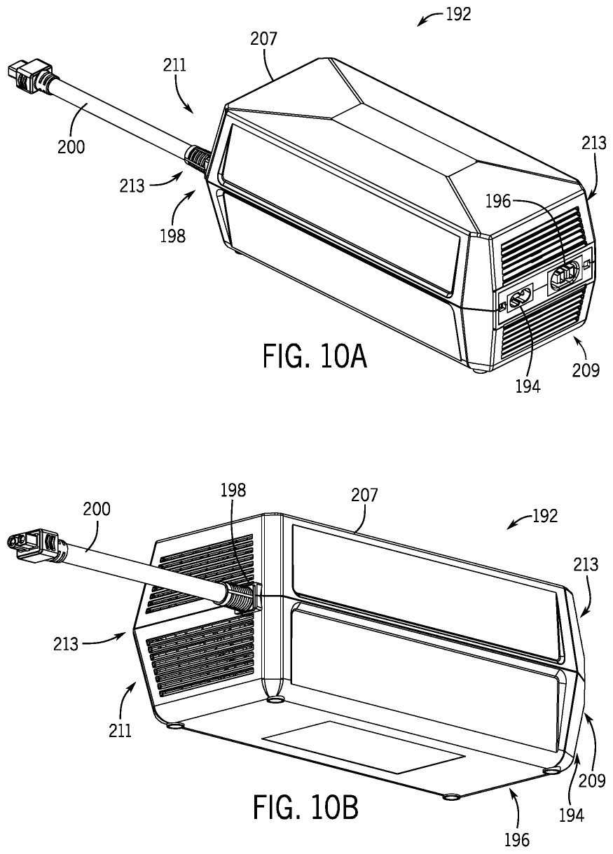

Referring now to FIG. 5, a rear view of the expansion battery 104 is shown with receptacle covers 129 exploded therefrom, according to an embodiment of the invention. The expansion battery 104 includes a pair of battery connection ports 132. Each of the battery connection ports 132 connect the expansion battery 104 to the power station 20 or to another expansion battery 104. The expansion battery 104 also includes a charging module input port 136 configured to connect to a power cord of a charging module (not shown in FIG. 5) that is configured to charge the expansion battery 104, as explained in more detail with respect to FIGS. 10A and 10B. The receptacle covers 129 protect the battery connection ports 132 and the charging module input port 136 from moisture, dirt, and other debris.

The expansion battery 104 generally includes a plurality of feet 131 extending downward from a bottom surface 133 of the housing 106 to secure the expansion battery in a stacked configuration or to raise the housing slightly off the floor or ground. An arc-shaped cutout 135 is shown extending through each of the feet 131 in a direction from the front sidewall 116 to a back sidewall 141 of the expansion battery 104. In various embodiments, the expansion battery 104 stacks on a power station 20 (FIG. 1) with the arc-shaped cutout 135 in the feet 131 sitting securely on the oval-shaped carrying handles 32 (FIG. 1) of the power station 20. While shown as arc-shaped in FIG. 5, the cutout 135 may have a different shape in various embodiments. In many embodiments, the shape of the cutout 135 will correspond to the shape of the carrying handles 32 such that the carrying handles 32 are able to safely support the expansion battery 104.

Referring now to FIG. 6, a rear view of the power station 20 connected to a pair of expansion batteries 128, 130 is shown, according to an embodiment of the invention. The expansion batteries 128, 130 are arranged similarly to the expansion battery 104 of FIG. 4, and thus, like elements therein are numbered identically to corresponding elements in the expansion battery 104 of FIG. 4. In FIG. 6, the external battery port 64 of the power station 20 is connected to a first expansion battery 128 and a second expansion battery 130. Each expansion battery 128, 130 may include a pair of battery connection ports 132 that connect to the power station 20 or the other expansion battery 128, 130 using a connection cable 134. Up to ten or more expansion batteries 128, 130 may be chained to the power station 20 to provide additional power. The battery system 108 of each expansion battery 128, 130 increases the battery or energy capacity (watt-hours (Wh) or joules (J)) or runtime of the power station 20. Alternatively, the expansion batteries 128, 130 could be configured to increase the running power or starting power of the power station 20. Each expansion battery 128, 130 also includes a charging module input port 136 for charging the expansion battery 128, 130.

As explained above, the control system 36 of the power station 20 is electrically coupled to the onboard battery system 34 and the external battery port 64 and may include a converter (not shown in FIG. 6) configured to convert a DC voltage to another DC voltage. As a result, the control system 36 of the power station 20 may utilize the converter to convert the DC voltage from the battery systems 108 of the expansion batteries 128, 130 into another DC voltage for distribution from the power station 20. The control system 36 of the power station 20 may additionally include a power inverter 40 to change DC power from each expansion battery 128, 130 to AC power for distribution from the power station 20. In another embodiment, the control system 110 of each expansion battery 128, 130 could provide a DC or AC power to the power station 20 that matches the requirements of any of the power output receptacles 48 of the power station 20. Accordingly, the control system 110 of each expansion battery 128, 130 may include a converter and/or inverter 138 to change DC power from the battery into an AC power supplied to the power station 20. The expansion batteries 128, 130 may also charge the onboard battery system 34 of the power station 20.

Each expansion battery 128, 130 may be paired to the power station 20 so that the control system 36 of the power station 20 can operate the expansion batteries 128, 130. Each expansion battery 128, 130 can be paired by connecting the expansion battery 128, 130 directly to the power station 20 and enabling a pairing feature on the power station 20. According to various embodiments of the invention, a user of the power station 20 may pair the expansion batteries 128, 130 to the power station 20 by performing a series of steps separately for each expansion battery 128, 130. Below is an example in which expansion battery 128 is paired to the power station 20.

In a first step, the user pairing the expansion battery 128 turns on the power station 20 and unplugs all electrical devices therefrom including any additional expansion batteries already connected and/or paired to the power station 20. In a second step, the user connects the expansion battery 128 being paired by connecting its connection cable 134 to the external battery port 64 of the power station 20. In a third step, the user holds down the overload reset button 60 (FIG. 1) of the power station 20 and presses the power button 82 (FIG. 3) of the power station 20 twice. Finally, the LED light 56 (FIG. 1) on the power station 20 will turn on and flash three times in a fourth step. If the LED light 56 does not turn on or flash three times, the user can repeat the second and third steps while ensuring that only the expansion battery 128 is connected to the power station 20. Once the expansion battery 128 is paired with the power station 20, the control system 36 of the power station 20 is able to communicate with and provide instructions to the control system 110 of the expansion battery 128.

In order to pair additional expansion batteries (for example, the expansion battery 130) to the power station 20, the user must disconnect the paired expansion battery 128 and repeat steps one through four above. Once the expansion batteries 128, 130 are paired to the power station 20, the expansion batteries 128, 130 will remain paired to the power station 20 until they are manually unpaired. In various embodiments, unpairing the expansion batteries 128, 130 may be performed by powering down or shutting down the expansion batteries 128, 130, by repeating steps one through four above, or by either method.

Pairing the expansion batteries 128, 130 allows the control system 36 of the power station 20 to discharge the battery system 34, 108 with the highest battery level before discharging the remaining batteries. In various embodiments, the battery level corresponds to a battery voltage and only the battery system or systems 34, 108 with the highest voltage will discharge until the voltage drops to approximately the same voltage level of the battery system or systems 34, 108 with the next highest battery voltage. That is, additional non-discharging battery systems 34, 108 will begin to discharge simultaneously with discharging battery systems 34, 108 when the voltages of the discharging battery systems 34, 108 approximate the voltages of the non-discharging battery systems 34, 108. In various embodiments, the voltages are approximate when the voltage levels or battery levels are within a specific percentage of each other such as 1%, 2%, 3%, 4%, or 5%, as non-limiting examples. However, in various embodiments, the voltages may be approximate when the voltage levels or battery levels are within a specific voltage level of each other such as 1V or 2V, as non-limiting examples.

For example, the battery system 34, 108 with the highest battery level among the expansion batteries 128, 130 and the power station 20 could discharge first until the battery level is similar to the battery system 34, 108 that had the second highest battery level. The two battery systems 34, 108 will then discharge simultaneously to the level of the third highest battery level. Once all remaining battery levels are similar, each battery system 34, 108 will discharge simultaneously or at the same rate. Thus, the battery systems 108 of the expansion batteries 128, 130 may only begin discharging if their battery levels are equal to or greater than the battery level of the battery system 34 of the power station 20.

Referring now to FIG. 7A, a power station assembly 140 including the power station 20 and the expansion batteries 128, 130 of FIG. 6 is shown in a stacked configuration, according to an embodiment of the invention. FIG. 7A shows the power station assembly 140 with two expansion batteries 128, 130 stacked on the power station 20, though any suitable number of expansion batteries could be stacked on the power station (for example, up to ten or more). The first expansion battery 128 is stacked directly on the carrying handles 32 of the power station 20. The second expansion battery 130 is stacked on the carrying handles 112 of the first expansion battery 128 via stacking adaptors 144. The stacking adaptors 144 sit or snap onto the carrying handles 112 of the first expansion battery 128 to secure the second expansion battery 130 to the first expansion battery 128.

The control system 36 of the power station 20 may be configured to determine a number of expansion batteries 128, 130 electrically coupled to the power station 20, determine a battery level of each expansion battery 128, 130, and calculate a battery level available to the power station 20 by adding together the battery level of each expansion battery 128, 130. In an alternative embodiment, the control system 36 may be configured to calculate a battery level available to the power station 20 by adding together the battery level of the onboard battery system 34 and the battery system 108 of each expansion battery 128, 130 electrically coupled to the power station 20. The automatic display 54 of the power station 20 operated by the control system 36 may display the available battery levels of the onboard battery system 34 and the battery systems 108 of the expansion batteries 128, 130.

The battery levels of the battery system 108 of each expansion battery 128, 130 electrically coupled to the power station 20 may comprise percent battery levels, and the battery level available to the power station 20 from battery system 34 and/or battery systems 108 may comprise a percent battery level relative to a capacity of the battery system 108 of a single expansion battery 128, 130 electrically coupled to the power station 20. The automatic display 54 may display the available battery level to the power station 20 as a percentage of a single expansion battery 128, 130 electrically coupled to the power station 20. That is, the automatic display 54 of the power station 20 may display that the total percent battery level is higher than 100% when the battery levels of the battery systems 108 of each expansion battery 128, 130 electrically coupled to the power station 20 have a total value greater than the capacity of the battery system 108 of a single expansion battery 128, 130. The automatic display 54 of the power station 20 may also display that the total percent battery level is higher than 100% when the battery levels of the battery system 34 of the power station 20 and each expansion battery 128, 130 electrically coupled to the power station 20 have a total value greater than the capacity of the battery system 108 of a single expansion battery 128, 130.

The control system 36 may calculate the power output and hours to empty for a particular load and operate the automatic display 54 to display the power output and/or hours to empty. The battery level available to the power station 20 is typically independent of an electrical load on the power station 20, but may be dependent on an electrical load on the power station 20 in some embodiments. Thus, the control system 36 may calculate the combined energy level of expansion batteries 128, 130 coupled to the power station 20 independent of or dependent on an electrical load on the power output receptacles 48 (FIG. 1).

Referring now to FIG. 7B, a pair of stacking adaptors between two expansion batteries is shown, according to an embodiment of the invention. Each stacking adaptor 144 has a lower surface with a semicircular cutout 155 extending a length of the stacking adaptor 144. The semicircular cutout 155 sits on rod-shaped carrying handles 112 of the first expansion battery 128. Each stacking adaptor 144 also has an oval-shaped upper surface 157 extending the length of the stacking adaptor 144. The second expansion battery 130 sits on the stacking adaptors 144 with the feet 131 of the second expansion battery 130 having arc-shaped cutouts 135 secured on the oval-shaped upper surface 157 of the stacking adaptors 144. Accordingly, the stacking adaptors 144 secure the feet 131 of the second expansion battery 130 to the rod-shaped carrying handles 112 of the first expansion battery 128 even if the feet 131 have a geometry that fits securely on oval-shaped carrying handles 32 (FIG. 1) of the power station 20. Although the handles 112 and feet 131 of the expansion batteries 128, 130 and the cutout 155 of the stacking adaptor 144 are described with particular shapes or configurations, in various embodiments, other shapes or configurations may be used. However, the handles 112 are typically designed for the comfort of a user.

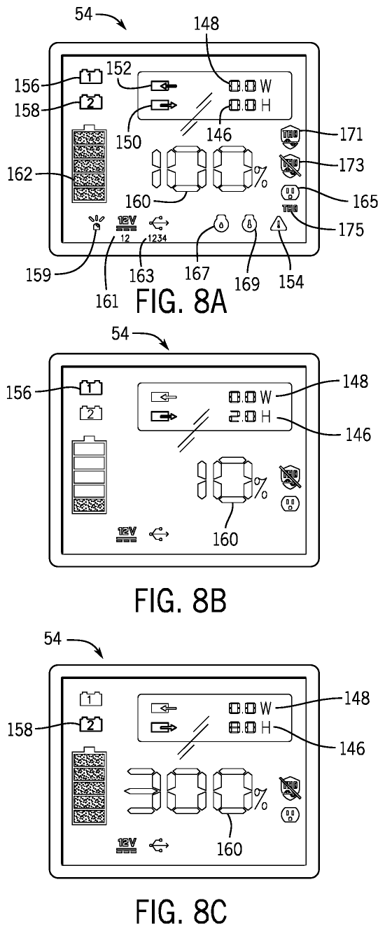

Referring now to FIGS. 8A-8C, the automatic display 54 for the power station 20 is shown, according to an embodiment of the invention. The automatic display 54 generally displays a variety of information including available battery level, input/output power, and charge/discharge times, as well as faults, errors, and protection codes to help diagnose malfunctions of the power station 20 and any connected expansion batteries (for example, expansion batteries 128, 130 shown in FIG. 6). In various embodiments, the top of the automatic display 54 shows input and output information (for example, watts (W), volts (V), amps (A), hours to full/empty (H)) and operational status of any connected expansion batteries while the bottom of the display shows available battery level and icons indicating which power outlet receptacles 48 are currently being used, specific warnings, and/or other faults and functions.

The automatic display 54 may include an Output icon 146 which displays watts (W), hours until empty (H), AC volts (V), or AC amps (A) on a rotating basis or based on a user selection. The automatic display 54 may include an Input icon 148 which displays watts (W) or hours until full (H) on a rotating basis or based on a user selection. A Battery Out icon 150 indicates a discharging battery, and a Battery In icon 152 indicates a charging battery. A Warning icon 154 flashes red when a battery or circuitry communication fault has occurred and is steady red when a battery management system (BMS) fault has occurred.

A Battery 1 icon 156 indicates that the automatic display 54 is showing battery information from the power station 20. When one or more expansion batteries are connected and paired to the power station, a Battery 2 icon 158 toggles on to indicate that the automatic display 54 is showing battery information from expansion batteries. The Battery 2 icon 158 may alternatively toggle on to indicate that the automatic display 54 is showing the combined battery information from the power station 20 and the connected expansion batteries. When expansion batteries are connected, the control system 36 of the power station 20 adds together the percent battery level of the battery system 108 of each expansion battery or the battery level of the battery system 108 of each expansion battery and the battery level of the onboard battery system 34, and the resulting hours until empty represents the total runtime available for the combined battery levels. Thus, when the Battery 2 icon 158 is illuminated, the control system 36 may operate the automatic display 54 to display the combined energy level of each expansion battery and/or the combined energy level of each expansion battery and the power station 20. However, in some embodiments, the automatic display 54 may include a Battery 3 icon (not shown) to display the combined energy level of each expansion battery and the power station 20.

An LED icon 159 indicates that the LED light 56 (FIG. 1) is on. A 12V icon 161 is steady blue to indicate that the 12V DC outlets 92, 94 (FIG. 3) are powered on and is steady red if a fault has occurred in the 12V DC outlets 92, 94. A USB icon 163 is steady blue to indicate that USB outlets 96, 98, 100 (FIG. 3) are powered on and is steady red if a fault has occurred in any of the USB outlets 96, 98, 100. A 120V icon 165 is steady blue to indicate that 120V AC outlets 102 (FIG. 3) are powered on and is steady red if an overload or fault has occurred in the inverter 40 (FIG. 1) or the 120V AC outlets 102.

A Low Temperature icon 167 is steady red if an internal temperature is too low. A High Temperature icon 169 is steady red if the internal temperature is too high. If the Battery 1 icon 156 is on, the Low Temperature icon 167 and the High Temperature icon 169 indicate that the power station 20 has experienced a low temperature event or a high temperature event, respectively. If the Battery 2 icon 158 is on, the Low Temperature icon 167 and the High Temperature icon 169 indicate that an expansion battery has experienced a low temperature event or a high temperature event, respectively.

To protect sensitive electronics, the control system 36 of the power station 20 may be programmed with a total harmonic distortion (THD) shield that safely stops the AC power output when the THD rises above a predetermined level or threshold (for example, 5%). The control system 36 will operate the automatic display 54 to selectively activate or control various icons based according to the THD shield programming. When the THD shield is enabled, the control system 36 operates the automatic display 54 to activate a THD Shield Enabled icon 171 to output a steady blue light. In that case, once the THD increases beyond the predetermined level, the control system 36 shuts off the AC power output of the power station 20 and operates the automatic display 54 to activate a THD icon 175 to output a steady red light. When the THD shield is disabled, the control system 36 operates the automatic display 54 to activate a THD Shield Disabled icon 173 to output a steady blue light if the THD is below the predetermined level. Once the THD goes over the predetermined level, the control system 36 operates the automatic display 54 to activate the THD Shield Disabled icon 173 and the THD icon 175 to output a flashing blue light and a flashing red light, respectively, but allows the power station 20 to continue to provide an AC power output.

As previously set forth above with respect to FIG. 7A, the control system 36 may operate the automatic display 54 to display the combined energy level of each expansion battery 128, 130 as a percentage of a maximum energy capacity of a battery system 108 of a single expansion battery 128, 130. Referring again to FIGS. 8A-8C with continued reference to FIG. 7A, the automatic display 54 may include a first fuel or battery gauge 160 that displays a percentage showing the percent battery level of the onboard battery system 34 of the power station 20 or of the battery systems 108 of the expansion batteries 128, 130. However, as similarly explained above, in some embodiments, the automatic display 54 may additionally or alternatively display the combined percent battery level of the battery systems 34, 108. When displaying expansion battery information, the first fuel gauge 160 reads higher than 100% when the combined energy levels of the battery systems 108 of the connected expansion batteries 128, 130 is higher than the maximum energy capacity of the battery system 108 of a single expansion battery 128, 130. The automatic display 54 may include a second fuel or battery gauge 162 that displays a number of bars (for example, 5 bars) that each represent a percent battery level of the onboard battery system 34 and/or the battery systems 108 of the expansion batteries 128, 130. When displaying expansion battery information, the second fuel gauge 162 will show as full when the battery levels of the battery systems 108 of all the connected expansion batteries 128, 130 and/or the battery system 34 of the power station 20 totals 100% or more of a capacity of the battery system 108 a single expansion battery 128, 130.

FIGS. 8B and 8C illustrate two examples of how the automatic display 54 of power station 20 can display a battery level. In FIG. 8B, the power station 20 is not connected to the expansion batteries 128, 130 or any other expansion batteries and is discharging. The automatic display 54 displays the hours to empty at 2.0H, the watts in at 0.0 W (in other words, the power station 20 is not charging), and the percent battery level of the onboard battery system 34 at 10%, with the Battery 1 icon 156 illuminated. In FIG. 8C, the power station 20 is connected to three expansion batteries (for example, the expansion batteries 128, 130 plus an additional expansion battery) each having a battery system 108 with a percent battery level at 100% and is discharging. The automatic display 54 displays the hours to empty at 8.0H, the watts in at 0.0 W, and the combined percent battery level of the three expansion batteries at 300%, with the Battery 2 icon 158 illuminated.

In an alternative embodiment, the control system 36 of the power station 20 may be programmed to calculate the total energy level of the onboard battery system 34 and the battery system 108 of each connected expansion battery and to operate the automatic display 54 to display the total energy level of the onboard battery system 34 and the battery system 108 of each expansion battery. For example, the onboard battery system 34 of the power station 20 may have a 100% battery level while connected to the battery systems 108 of the expansion batteries 128, 130 each at 100% battery level. If the power station 20 is operating in a discharge mode, the automatic display 54 may display hours to empty at 8.0H, the watts in at 0.0 W, and the combined percent battery level of the onboard battery system 34 and the battery systems 108 of the expansion batteries 128, 130 at 300%, with the combined percent battery level displayed as a percent relative to the capacity of the onboard battery system 34.

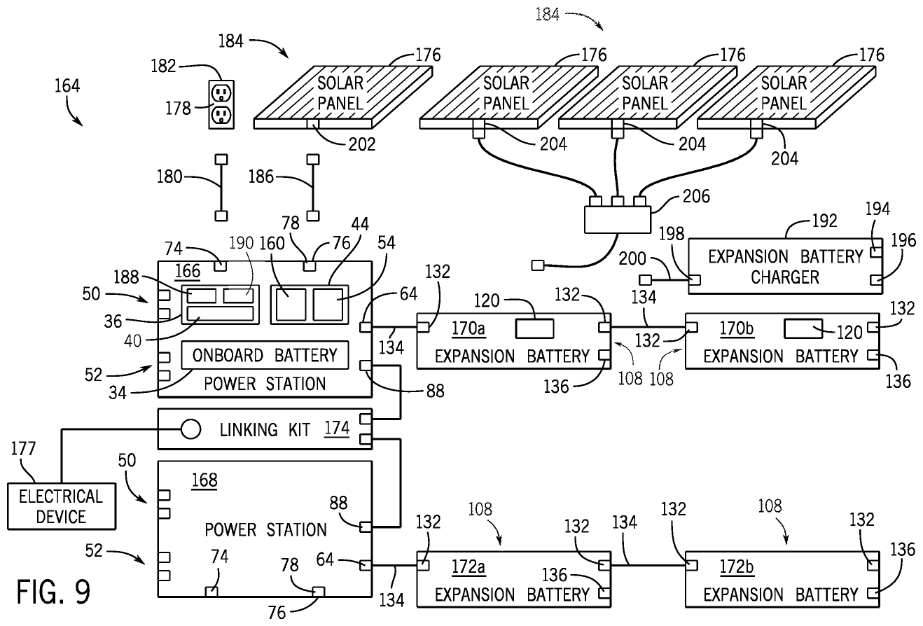

Referring now to FIG. 9, a block diagram of a power station assembly 164 is shown, according to an embodiment of the invention. The power station assembly 164 is shown with a first power station 166 coupled to a second power station 168 by a linking kit or module 174 that increases the available power output to an electrical device 177 powered by the power station assembly 164. The first and second power stations 166, 168 are arranged similarly to the power station 20 of FIG. 1, and hence, like elements therein are numbered identically to corresponding elements in the power station 20 of FIG. 1. A first pair of expansion batteries 170a, 170b are coupled to the first power station 166 and a second pair of expansion batteries 172a, 172b are coupled to the second power station 168. The first pair of expansion batteries 170a, 170b and the second pair of expansion batteries 172a, 172b increase the capacity or runtime of the power station assembly 164. The expansion batteries 170a, 170b, 172a, 172b are arranged similarly to the expansion battery 104 of FIG. 4 and the expansion batteries 128, 130 of FIG. 6, and thus, like elements therein are numbered identically to corresponding elements in the expansion battery 104 of FIG. 4 and the expansion batteries 128, 130 of FIG. 6.

The power stations 166, 168 may each include one or more linking kit connection ports 88 configured to receive connections to the linking kit 174. The linking kit 174 may be used as a parallel link to couple together the AC power outputs from the linking kit connection ports 88 of the two power stations 166, 168 to increase output current or a series link to couple together the AC power outputs from the linking kit connection ports 88 of the two power stations 166, 168 to increase output voltage. The power stations 166, 168 are also shown with an external battery port 64 configured to connect expansion batteries 170a, 170b, 172a, 172b, a DC power inlet receptacle 76 configured to connect to a DC power source 184, and an AC power inlet receptacle 74 configured to connect to an AC power source 178. The power stations 166, 168 may also include DC power output receptacles 50 and AC power output receptacles 52 configured to power electrical devices coupled to the power station 166, 168.

The AC power inlet receptacle 74 couples to the AC power source 178 using an AC cord 180. The AC power source 178 may be a traditional wall outlet 182 coupled to the utility grid. The AC power inlet receptacle 74 may support AC fast charging (for example, at 120V AC, 50 Hz/60 Hz, 4.5 A MAX). The DC power inlet receptacle 76 may include an APP input port 78 configured to couple to the DC power source 184 using an APP cord 186. The DC power source 184 may include one or more solar panels 176. The APP input port 78 may support DC fast charging (for example, at 10V-28V DC, 25 A MAX).

The power stations 166, 168 also include a control system 36 including an inverter 40, a processor 188 and memory 190. While the inverter 40 is illustrated as part of the control system 36, the inverter 40 may be controlled by the control system 36 as a separate element therefrom. The processor 188 may be one or more computer processors or microprocessors capable of executing a computer program having instructions including executable code. The executable code may be stored on the memory 190, which may include any suitable non-transitory media that can store executable code for use by the processor 188 to perform the presently disclosed techniques. The memory 190 may be any suitable type of computer-readable media that can store the executable code, data, analysis of the data, or the like. The power stations 166, 168 may also include a control panel 44 having an automatic display 54 and a battery gauge 160.

An expansion battery charger or charging module 192 is configured to charge the first pair of expansion batteries 170a, 170b and the second pair of expansion batteries 172a, 172b. The expansion battery charging module 192 may receive power from the AC power source 178 and/or the DC power source 184 and supply the power to one expansion battery 170a, 170b, 172a, 172b using a power cord 200. The expansion battery charging module 192 includes an AC input port 194, an APP input port 196, and a power DC output port 198. The AC input port 194 is configured to couple to an AC power source such as, for example, the AC power source 178 using the AC cord 180. The APP input port 196 is configured to couple to a DC power source such as, for example, the DC power source 184 using the APP cord 186.

The expansion batteries 170a, 170b, 172a, 172b may include a charging module input port 136 that connects to the power output port 198 of the expansion battery charging module 192 using the power cord 200. The expansion batteries 170a, 170b, 172a, 172b may also include a pair of battery connection ports 132 that couple to a battery connection port 132 of another expansion battery 170a, 170b, 172a, 172b or to the external battery port 64 of a power station 166, 168. A connection cable 134 may electrically couple the expansion batteries 170a, 170b, 172a, 172b to the power stations 166, 168 when coupled to one battery connection port 132 and one external battery port 64. The first pair of expansion batteries 170a, 170b and the second pair of expansion batteries 172a, 172b may each be connected to one or more additional expansion batteries (not shown in FIG. 9) to increase the battery capacity available to the power stations 166, 168.

In various embodiments, the solar panels 176 of the DC power source 184 may be rated between 10V-28V with MC4 or APP connectors and may power one or more of the power stations 166, 168 or expansion batteries 170a, 170b, 172a, 172b via the expansion battery charging module 192. The solar panels 176 may include APP connectors 202 that can be coupled directly to the APP input ports 78 of the power stations 166, 168 or the APP input port 196 of the expansion battery charging module 192. The solar panels 176 may alternatively include MC4 connectors 204 that can be connected to the APP input ports 78, 196 using an MC4 to APP solar charge harness 206. The solar charge harness 206 may have an APP plug connectable to the power stations 166, 168 and the expansion battery charging module 192 with MC4 connections such as, for example, three MC4 connections to couple up to three or more solar panels 176 having MC4 connectors 204.

In some embodiments of the invention, the capacity of the onboard battery system 34 and/or each expansion battery 170a, 170b, 172a, 172b could have an approximate (within plus or minus 5%) capacity of 1600 Wh or 3200 Wh. The onboard battery system 34 and/or each battery system 108 of the expansion batteries 170a, 170b, 172a, 172b may have a rated output voltage of approximately 46.8V and a max output voltage of approximately 54.6V-55V, although the battery systems 34, 108 could have any suitable voltage rating such as 12V, 24V, or 48V, as non-limiting examples. The percent battery level of the battery systems 34, 108 may correspond to the battery voltage. As a non-limiting example, 100% battery level could correspond to 55V, and 0% battery level could correspond to 38V. In various embodiments, the power stations 166, 168 may each provide single phase AC power at 60 Hz with a current rating of approximately 13.3 A at 120V.

Referring now to FIGS. 10A-10B, the charging module 192 for expansion batteries, such as, for example, the expansion battery 104 of FIG. 4, the expansion batteries 128, 130 of FIG. 6, and the expansion batteries 170a, 170b, 172a, 172b of FIG. 9, is shown, according to an embodiment of the invention. The expansion battery charging module 192 is a power converter that changes power from an AC power source and/or a DC power source into a form required to charge expansion batteries. The expansion battery charging module 192 includes a generally rectangular housing 207 having a first end 209 opposite a second end 211 with the AC input port 194 and the APP input port 196 in the first end 209 and the power output port 198 in the second end 211. A power cord 200 is couplable between the power output port 198 and an expansion battery. The AC input port 194 may support AC fast charging from a wall outlet (for example, at 120V AC, 50 Hz/60 Hz, 4.5 A MAX). The APP input port 196 may support DC fast charging from a DC power source (for example, at 10V-28V DC, 25 A MAX). In various embodiments, the expansion battery charging module 192 outputs power at 55V DC with a maximum current of 8 A or 16 A to charge an expansion battery. A plurality of cooling vents 213 are located in the first end 209 and the second end 211 for cooling air to flow through the housing 207.

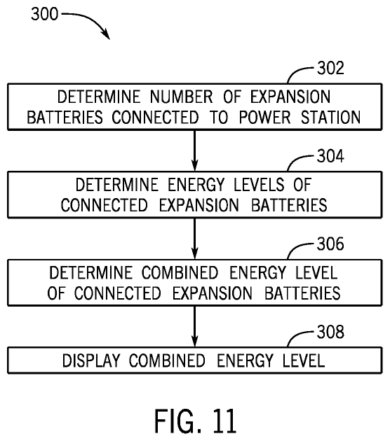

Referring now to FIG. 11 with continued reference back to FIG. 9, a flow diagram of a process 300 used to determine an energy level available to the power station assembly 164 is illustrated, in accordance with an embodiment of the invention. As similarly explained above, the term energy level is used interchangeably with the terms battery level, charge level, and state of charge. The process 300 begins at STEP 302 by determining a number of expansion batteries 170a, 170b electrically coupled to the power station 166 to provide additional power thereto. The control system 36 of the power station 166 may be programmed to sense each expansion battery 170a, 170b coupled to the power station 166. The control system 36 may be programmed to do this by determining which expansion batteries 170a, 170b are paired with the power station 166 and/or communicating with the control system 110 of each paired expansion battery 170a, 170b. The process 300 continues at STEP 304 by determining an energy level of the battery system 108 of each expansion battery 170a, 170b. The control system 36 may be programmed to determine the energy level of the battery system 108 of each expansion battery 170a, 170b by reading the battery gauge 120 on each expansion battery 170a, 170b. Detailed explanations of how the control systems 36, 110 of the power station 20 and expansion batteries 170a, 170b may determine the percent battery level of the battery systems 34, 108 are provided above in more detail with respect to FIGS. 1 and 4, and those explanations are applicable to the process 300 as well.

The process 300 continues at STEP 306 by calculating the combined energy level of each expansion battery 170a, 170b. The control system 36 may add together the percent energy level of each expansion battery 170a, 170b to determine the combined energy level. The process 300 concludes at STEP 308 by controlling the automatic display 54 of the power station 166 to display the energy level available to the power station 166 from each expansion battery 170a, 170b as a percentage of a capacity of the battery system 108 of one of the expansion batteries 170a, 170b electrically coupled to the power station 166. The percentage is greater than 100% when the energy level available to the power station is greater than a capacity of the battery system 108 of one of the expansion batteries 170a, 170b electrically coupled to the power station 166. A detailed explanation of how the control system 36 may calculate and display an energy level on a power station is provided above in more detail with respect to FIGS. 7A-8C, and that explanation is also applicable to the process 300.

A technical contribution for the disclosed system and method is that it provides for a computer implemented method of determining an energy level available to a power station 166 from one or more expansion batteries 170a, 170b. In various embodiments, a non-transitory computer readable storage medium 190 has stored thereon a computer program for calculating and displaying the available state of charge to the power station 166 from one or more expansion batteries 170a, 170b. The computer program may include instructions that, when executed by a processor 188, cause the processor to determine a state of charge of the onboard battery system 34, determine a state of charge of each expansion battery 170a, 170b, and calculate the available state of charge to the power station by adding together the state of charge of each expansion battery. The instructions may cause the processor to control an automatic display 54 to display the available state of charge to the power station 166 separately from a state of charge of the onboard battery system 34.

One skilled in the art will appreciate that embodiments of the invention may be interfaced to and controlled by a computer readable storage medium having stored thereon a computer program. The computer readable storage medium includes a plurality of components such as one or more of electronic components, hardware components, and/or computer software components. These components may include one or more computer readable storage media that generally stores instructions such as software, firmware and/or assembly language for performing one or more portions of one or more implementations or embodiments of a sequence. These computer readable storage media are generally non-transitory and/or tangible. Examples of such a computer readable storage medium include a recordable data storage medium of a computer and/or storage device. The computer readable storage media may employ, for example, one or more of a magnetic, electrical, optical, biological, and/or atomic data storage medium. Further, such media may take the form of, for example, floppy disks, magnetic tapes, CD-ROMs, DVD-ROMs, hard disk drives, and/or electronic memory. Other forms of non-transitory and/or tangible computer readable storage media not listed may be employed with embodiments of the invention.

A number of such components can be combined or divided in an implementation of a system. Further, such components may include a set and/or series of computer instructions written in or implemented with any of a number of programming languages, as will be appreciated by those skilled in the art. In addition, other forms of computer readable media such as a carrier wave may be employed to embody a computer data signal representing a sequence of instructions that when executed by one or more computers causes the one or more computers to perform one or more portions of one or more implementations or embodiments of a sequence.

Beneficially, embodiments of the invention provide a system and method for determining a battery level available to a power station including an onboard battery system connected to one or more expansion batteries each including a battery system. The power station includes a control system that determines a battery level of an onboard battery system and a battery level of the battery system of each expansion battery electrically coupled to the power station. The control system may further calculate a combined battery level that includes the battery level of each expansion battery and/or the battery level of the onboard battery system of the power station. A digital display indicates the battery level of the onboard battery system and the combined battery level of the battery system of each expansion battery and/or the onboard battery system of the power station so that an operator knows the battery level available for a particular load.

Therefore, according to one embodiment of the invention, a power station assembly includes a plurality of expansion batteries each including a battery system and a power station couplable to the plurality of expansion batteries to receive power therefrom. The power station includes an onboard battery system and a control system. The control system is configured to determine how many expansion batteries of the plurality of expansion batteries are electrically coupled to the power station, determine a battery level of the battery system of each expansion battery electrically coupled to the power station, and calculate a battery level available to the power station by adding together the battery level of the battery system of each expansion battery electrically coupled to the power station.

According to another embodiment of the invention, a non-transitory computer readable storage medium has stored thereon a computer program for calculating and displaying the state of charge available to a power station. The computer program includes instructions that cause a processor to determine a number of expansion batteries electrically coupled to and configured to provide power to the power station, with each expansion battery including a battery system. The computer program instructions further cause a processor to determine a state of charge of the battery system of each expansion battery and calculate the state of charge available to the power station by adding together the state of charge of the battery system of each expansion battery.

According to yet another embodiment of the invention, a power station connectable to one or more expansion batteries includes an onboard battery system, an automatic display, at least one power output receptacle powered by the onboard battery system, an external battery port electrically connectable to one or more expansion batteries each including a battery system, and a control system electrically coupled to the onboard battery system and the external battery port. The control system is programmed to determine an energy level of the onboard battery system and the battery system of each of the one or more expansion batteries electrically connected to the external battery port, calculate the combined energy level of the battery systems of the one or more expansion batteries electrically connected to the external battery port, and operate the automatic display to display the energy level of the onboard battery system and the combined energy level of the battery systems of the one or more expansion batteries electrically connected to the external battery port.

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. The singular forms ‘a’, ‘an’, and ‘the’ in the claims include plural reference unless the context clearly dictates otherwise. Additionally, while various embodiments of the invention have been described, it is to be understood that aspects of the invention may include only some of the described embodiments. Accordingly, the invention is not to be seen as limited by the foregoing description but is only limited by the scope of the appended claims.

What is claimed is:

1. A power station assembly comprising:
a plurality of expansion batteries each comprising a battery system;
a power station couplable to the plurality of expansion batteries to receive power therefrom, the power station comprising:
an onboard battery system; and
a control system configured to:
determine how many expansion batteries of the plurality of expansion batteries are electrically coupled to the power station;
determine a battery level of the battery system of each expansion battery electrically coupled to the power station; and
calculate a battery level available to the power station by adding together the battery level of the battery system of each expansion battery electrically coupled to the power station.

2. The power station assembly of claim 1 wherein the control system is configured to determine the battery level of the battery system of each expansion battery electrically coupled to the power station as a percent battery level.

3. The power station assembly of claim 1 wherein:
the power station further comprises an automatic display; and
the control system is configured to operate the automatic display to display the battery level available to the power station.

4. The power station assembly of claim 3 wherein the control system is configured to:
calculate the battery level available to the power station as a percent battery level relative to a capacity of the battery system of a single expansion battery electrically coupled to the power station; and
operate the automatic display to display the percent battery level at higher than 100% when a combined battery level of the battery system of each expansion battery electrically coupled to the power station is greater than the capacity of the battery system of the single expansion battery.

5. The power station assembly of claim 3 wherein the control system is further configured to determine a battery level of the onboard battery system and operate the automatic display to display the battery level of the onboard battery system.

6. The power station assembly of claim 1 wherein:
the power station further comprises at least one power output receptacle powered by the onboard battery system; and
the control system comprises an inverter to convert DC power from the onboard battery system to AC power supplied to the at least one power output receptacle.

7. The power station assembly of claim 1 wherein the control system is further configured to:
determine a battery level of the onboard battery system; and
calculate the battery level available to the power station by adding together the battery level of the battery system of each of the expansion batteries electrically coupled to the power station and the battery level of the onboard battery system.

8. The power station assembly of claim 1 wherein the control system is configured to calculate the battery level available to the power station independent of any electrical loads on the power station.

9. The power station assembly of claim 1 further comprising a parallel link configured to couple the power station to another power station.

10. A non-transitory computer readable storage medium having stored thereon a computer program for calculating and displaying the state of charge available to a power station, the computer program comprising instructions that cause a processor to:
determine a number of expansion batteries electrically coupled to and configured to provide power to the power station, each expansion battery comprising a battery system;
determine a state of charge of the battery system of each expansion battery; and
calculate the state of charge available to the power station by adding together the state of charge of the battery system of each expansion battery.

11. The non-transitory computer readable storage medium of claim 10 wherein the instructions further cause the processor to control a display panel to display the state of charge available to the power station.

12. The non-transitory computer readable storage medium of claim 11 wherein the instructions further cause the processor to:
determine the state of charge available to the power station as a percentage of a capacity of the battery system of one expansion battery electrically coupled to the power station; and
control the display panel to display the state of charge available to the power station.

13. The non-transitory computer readable storage medium of claim 12 wherein the instructions further cause the processor to determine that the percentage is greater than 100% when the state of charge available to the power station is greater than the capacity of the battery system of the one expansion battery electrically coupled to the power station.

14. The non-transitory computer readable storage medium of claim 10 wherein the instructions further cause the processor to:
determine a state of charge of the power station; and
control a display panel of the power station to separately display the state of charge of the power station and the state of charge available to the power station.

15. The non-transitory computer readable storage medium of claim 10 wherein the instructions further cause the processor to:
determine a state of charge of an onboard battery system of the power station; and
calculate the state of charge available to the power station by adding together the state of charge of the battery system of each expansion battery and the state of charge of the onboard battery system.

16. The non-transitory computer readable storage medium of claim 15 wherein the instructions further cause the processor to operate a power inverter of the power station to convert DC power from the onboard battery system of the power station and the battery system of each expansion battery electrically coupled to the power station to AC power.

17. The non-transitory computer readable storage medium of claim 10 wherein the instructions further cause the processor to determine a state of charge of the battery system of each expansion battery by accessing a battery gauge stored in a control system of each expansion battery.

18. A power station connectable to one or more expansion batteries, the power station comprising:
an onboard battery system;
an automatic display;
at least one power output receptacle powered by the onboard battery system;
an external battery port electrically connectable to one or more expansion batteries each comprising a battery system; and
a control system electrically coupled to the onboard battery system and the external battery port, the control system programmed to:
determine an energy level of the onboard battery system and the battery system of each of the one or more expansion batteries electrically connected to the external battery port;
calculate the combined energy level of the battery systems of the one or more expansion batteries electrically connected to the external battery port; and
operate the automatic display to display the energy level of the onboard battery system and the combined energy level of the battery systems of the one or more expansion batteries electrically connected to the external battery port.

19. The power station of claim 18 wherein the control system comprises an inverter coupling the onboard battery system and the external battery port to the at least one power output receptacle.

20. The power station of claim 18 wherein the onboard battery system comprises a rechargeable lithium-ion battery.

21. The power station of claim 18 wherein the control system calculates the combined energy level of the battery systems of the one or more expansion batteries independent of any electrical loads on the at least one power output receptacle.

22. The power station of claim 18 wherein the control system is programmed to operate the automatic display to display the combined energy level of the battery systems of the one or more expansion batteries electrically connected to the external battery port as a percentage of a maximum energy capacity of the battery system of a single expansion battery of the one or more expansion batteries.

23. The power station of claim 22 wherein the control system is programmed to cause the automatic display to display the percentage as higher than 100% when the combined energy level of the battery systems of the one or more expansion batteries electrically connected to the external battery port is higher than the maximum energy capacity of the battery system of the single expansion battery.

24. The power station of claim 18 wherein the control system is further programmed to:
calculate the total energy level of the onboard battery system and the battery system of each of the one or more expansion batteries electrically connected to the external battery port; and
operate the automatic display to display the total energy level of the onboard battery system and the battery systems of the one or more expansion batteries electrically connected to the external battery port.
